(19) United States
(12) Patent Application Publication
(10) Pub. No.: US 2010/0101240 A1
(43) Pub. Date: Apr. 29, 2010

(54) Configurations and Methods for Ambient Air Vaporizers

(75) Inventor: John Mak, Santa Ana, CA (US)

Correspondence Address: FISH & ASSOCIATES, PC;ROBERT D. FISH, 2603 Main Street, Suite 1000, Irvine, CA, 92614-6232, US

(73) Assignee: FLUOR TECHNOLOGIES CORPORATION, Aliso Viejo, CA (US)

(21) Appl. No.: 12/597,058

(22) PCT Filed: May 23, 2008
(86) PCT No.: PCT/US08/06605

§ 371 Date: Nov. 30, 2009

Related U.S. Application Data
(60) Provisional application No. 60/940,066, filed on May 24, 2007.
(60) Provisional application No. 60/942,150, filed on Jun. 5, 2007.

(51) Int. Cl. F17C 9/02

(52) U.S. Cl. 62/50.2

(57) ABSTRACT

Cryogenic fluid is vaporized using two sections of an ambient air vaporizer where in the first section ambient air is dehydrated at a temperature at or above freezing point of water using refrigeration content of partially heated cryogenic fluid, wherein the dehydrated air is used in the second section to form the partially heated cryogenic fluid from a cryogenic fluid.

This application claims priority to our copending U.S. provisional applications having Ser. No. 60/940,066 (filed May 24, 2007) and Ser. No. 60/942,150 (filed Jun. 5, 2007).

### FIELD OF THE INVENTION

The field of the invention is configurations and methods of vaporization of cryogenic gases, and especially liquefied natural gas (LNG) using ambient air as heat source.

### BACKGROUND OF THE INVENTION

Atmospheric ambient air vaporizers are well known in the art and commonly used in many cryogenic liquid plants to vaporize various cryogenic liquids, and especially liquefied natural gas. Atmospheric vaporizers are typically based on heat exchanger configurations in which sensible heat of air and latent heat of water is used to heat a very low boiling cryogenic liquid (e.g., liquid oxygen, liquid nitrogen, or liquefied natural gas) to a temperature above the boiling point.

Unfortunately, the vaporization duty of currently known ambient air vaporizers is small when compared to the large duties required by LNG regasification terminals. Therefore, most known ambient air vaporizers for regasification of LNG require a rather significant footprint, which is often uneconomical or even impractical, particularly in offshore and floating LNG regasification facilities.

State of the art ambient air vaporizers/heat exchangers typically include a number of individual multi-finned heat transfer elements in various serial and/or parallel configurations. Such finned heat exchangers are relatively efficient for transferring heat from the ambient air to vaporize and superheat LNG. Most of these exchangers are in vertical orientation and have counter current flow between the downward cold denser air (due to gravitational force) and the upward flow of the LNG in the vaporizer tubes. Typical examples for such configurations are described in U.S. Pat. Nos. 4,479,359, 5,174,371, and 5,251,452. Further known LNG regasification configurations with heat exchange fluid or direct heating are described in U.S. Pat. App. No. 2006/0196449.

While most of such ambient air exchangers regasify LNG relatively efficiently during at least some period of operation, ice formation and accumulation on the outer fins, especially in the lower part of the exchangers where the LNG enters; impedes heat transfer due to the insulating property of ice. Moreover, ice layers may be unevenly distributed along the tubes, adding weight to the exchangers, and potentially even changing the center of gravity of the exchanger. Excessive ice layer formation is also problematic in the structural design to meet stringent structural code requirements for wind and seismic loads.

Where ice layers have built up to an unacceptable level, LNG vaporization is typically stopped and the exchanger is placed on a standby de-icing cycle. In many cases, de-icing is done by natural draft convection, which is time consuming. To reduce de-icing time in conventional exchangers, one or more force draft air fans may be employed. However, such operation is rarely effective due to additional ice formation that further inhibits the heating operation, while requiring high energy consumption of the air circulation fans (e.g., in hot and humid environment, over 50% of the operational cost for heat exchangers is due to de-icing or defrosting requirements). Operation of most known ambient air vaporizers is also subject to environmental factors such as temperature, relative humidity, wind, solar radiation, and/or surrounding structures. Even circadian variations in humidity and dry bulb temperature may affect the heat exchanger performance. To reduce ice formation, an intermediate heat transfer fluid cycle may be used to cool and partially dehydrate ambient air prior to forcing the cooled air into the air vaporizer as described in U.S. Pat. App. No. 2007/0214806 and 2007/0214807. Alternatively, direct heating may be employed to reduce or even prevent ice formation as described in U.S. Pat. No. 7,155,917. Despite some advantages obtained in such devices and methods, pumping, heating, and temperature regulation of the intermediate heat transfer fluid requires considerable energy and adds to the complexity and space requirements of the LNG vaporizers.

Therefore, while numerous configurations and methods of ambient air vaporization of LNG are known in the art, all or almost all of them suffer from one or more disadvantages. Thus, there is still a need to provide improved configurations and methods for regasification of LNG.

### SUMMARY OF THE INVENTION

The present invention is directed to various configurations and methods of vaporizing a cryogenic fluid in an ambient air vaporizer in which water is condensed from the ambient air using refrigeration content of partially heated cryogenic fluid to so form dehydrated air that is then employed to heat the cryogenic fluid, thereby producing the partially heated cryogenic fluid. Consequently, continuous operation without need for defrosting cycles and/or defrosting fluid is possible at reduced energy consumption.

In one aspect of the inventive subject matter, an ambient air vaporizer includes a partitioned enclosure that at least partially encloses a plurality of vaporization conduits, wherein a first section of the enclosure is separated from a second section by a collection tray.

Most preferably, the first section allows condensation of water from ambient air at a temperature of at least 32° F. and further allows formation of dehydrated air using the vaporization conduits as cold source, and the collection tray allows passage of the dehydrated air from the first section to the second section and removal of condensate from the first section. It is especial preferred that in such vaporizers the second section allows heating of a cryogenic fluid in the vaporization conduits using the dehydrated air, and that the vaporization conduits extend across the first and second section.

Most preferably, the first section comprises a coalescing filter or element and a drain fluidly coupled to the collection tray, and the first and second sections are vertically coupled to each other to allow top-to-bottom or downward air flow. It is also preferred that a fan is coupled to the enclosure and forces ambient air into the first section. While not limiting to the inventive subject matter, it is generally further preferred that a control system maintains the air temperature in the first section above 32° F., for example, by controlling flow of vaporized cryogenic fluid out of the first section and/or by controlling flow of the cryogenic fluid into the second section. Alternatively, or additionally, a control system is contemplated that reduces the feed rate of cryogenic fluid to the vaporizer allowing a controlled defrosting process using heat from the ambient air and the coalescer trays in the upper section, to so avoid the hazard associated with falling ice in conventional ambient air vaporizers.

Viewed from a different perspective, especially preferred vaporizers for cryogenic fluids will include an enclosure with a first section and a second section that both at least partially enclose one or more vaporization conduits (typically fined exchanger tubes), wherein first and second sections allow heating of a cryogenic fluid in the vaporization conduit using air in the second section to a temperature such that the heated cryogenic fluid has a temperature in the first section effective to condense but not freeze moisture of the air in the first section.

In such devices, it is still further generally preferred that a drain portion and a collection tray (positioned between the first and second sections), wherein the tray allows passage of the air from the first to the second section and allows withdrawal of condensate from the first section. Most typically, a fan will be coupled to the enclosure to force movement of air from the outside the enclosure through the first section, the collection tray, and the second section. As discussed above, it is also preferred that a control system maintains the air temperature in the first section at, near (e.g., +/−5° F.), or above 32° F., for example, by controlling flow of the cryogenic fluid into or out of the vaporization conduit. In further preferred aspects, a coalescing filter or element is included in the first section.

Consequently, a method of vaporizing a cryogenic fluid (e.g., LNG) in a vaporization conduit using ambient air is contemplated in which partially heated cryogenic fluid is used to chill and dehydrate ambient air to a temperature of no lower than 32° F. Condensate is then removed from the dehydrated air, and the chilled and dehydrated air is then used to form the partially heated cryogenic fluid from the cryogenic fluid. Most typically, the step of dehydrating the ambient air is performed in a first section of the vaporizer that is separate from a second section in which the partially heated cryogenic fluid is formed. While not limiting to the inventive subject matter, it is preferred that the temperature of the first section is maintained by a control system, typically via control of flow of the cryogenic fluid in the vaporization conduit (e.g., the control system controls efflux of the vaporized cryogenic fluid from the first section and/or influx of the cryogenic fluid into the second section). Most typically, the step of removing condensate is performed using a coalescence filter and a collection tray that is disposed between the first and second sections.

Various objects, features, aspects and advantages of the present invention will become more apparent from the following detailed description of preferred embodiments of the invention.

### BRIEF DESCRIPTION OF THE DRAWING

FIG. 1 is one schematic illustration of an ambient air vaporizer according to the inventive subject matter.

FIG. 2 is another schematic illustration of an ambient air vaporizer according to the inventive subject matter in which a control system controls the temperature by regulating efflux of vaporized cryogenic fluid.

FIG. 3 is a further schematic illustration of an ambient air vaporizer according to the inventive subject matter in which a control system controls the temperature by regulating influx of cryogenic fluid.

### DETAILED DESCRIPTION

The inventor has discovered that defrosting of ambient air vaporizers can be reduced or even be entirely avoided in devices and methods in which water is condensed and removed from ambient air in a section of the vaporizer that operates at a temperature at about or above the freezing point of water and in which the so cooled and dried air is then further used for vaporization in another section of the exchanger. Most preferably, such sections are arranged in series and employ forced air flow, and the moisture is removed from the warm section of the vaporizer using various devices that may include a coalescence filter, separation device and condensate drain system. Most preferably, a control system is implemented that provides frost free operation under various ambient temperatures and relative humidities.

It should be appreciated that such configurations eliminate or reduce defrosting time, increase the on-stream operation, and reduce heat exchange size and plant footprint. It should also be noted that in contemplated water removal configurations, the air that flows to the lower section is almost completely dried, thus avoiding ice formation on the lower section where the cryogenic fluid enters, resulting in a colder air (typically −50° F. to −100° F.) leaving the bottom of the vaporizer, and smaller heat exchangers. Furthermore, it should be noted that contemplated configurations and methods are especially advantageous in tropical locations where the ambient air is warm and has a high humidity. Avoiding of icing on the exchanger fins will thus greatly improve the efficiency of the LNG heating cycle with reduced space requirements. Where desired (e.g., in off-shore regasification terminals), preferred configurations and methods may include a step of boosting the LNG pressure to pipeline pressure prior to heating the LNG in contemplated ambient air heaters. It is typically preferred that the ambient air vaporizers have a vertical tube orientation, wherein the water is condensed from the air and removed by gravity, while tubes are heated by ambient air in natural convection mode or in forced convection with induced air fans. Additionally, contemplated devices and methods may also be combined with those described in our co-pending provisional patent application with the Ser. No. 60/899,292 (filed Feb. 1, 2007), which is incorporated by reference herein.

Thus, contemplated vaporizers for a cryogenic fluid, and especially LNG will include an enclosure (typically open-ended at top and bottom) with at least two sections that at least partially enclose a vaporization conduit, wherein first and second sections are configured and dimensioned to allow heating of a cryogenic fluid in the vaporization conduit using air in the second section to a temperature such that the heated cryogenic fluid has a temperature in the first section effective to condense but not freeze moisture of the air in the first section. The so condensed water is typically formed by a coalescence filter and removed from the enclosure via a collection tray that includes a plurality of openings to allow the air to flow from a section above the tray to a section below the tray. The tray or housing will then further include a drain element that allows removal of the water from the section. Of course, it should be appreciated that more than one water removal sections may be used, especially where the vaporizer is located in a relatively humid climate. Moreover, it is generally preferred that the vaporizer will include a force draft fan or other air moving device (e.g., blower, jet, etc.) that allows forced movement of the ambient air on a top-to-bottom direction.

Viewed from a different perspective, it should be appreciated that preferred vaporizers includes a partitioned enclosure that is configured to at least partially enclose a plurality of vaporization conduits (preferably extending across the first and second sections), wherein a first section of the enclosure is separated from a second section by a collection tray. Most typically, the first section is configured to allow condensation of water from ambient air at a temperature of at least 32° F. and to allow formation of dehydrated air using the vaporization conduits as cold source. The collection tray is configured to allow passage of the dehydrated air from the first section to the second section and to allow removal of condensate from the first section, and the second section is configured to allow heating of a cryogenic fluid in the vaporization conduits using the dehydrated air.

In one especially preferred configuration, ambient air is used to provide heating to LNG using dual section air vaporizer design and configuration. The top section heats the LNG stream 9 from about 20° F. to 40° F. and the bottom section heats the LNG stream 8 from −250° F. to 20° F. LNG is typically heated in the ambient air vaporizer in vertical orientation with ambient air descending, using either natural convection or induced draft fans. Since almost all the water is removed from the ambient air in the top section, the dried air (water depleted air) can be used to further heat the cold LNG in the lower section without the known icing problems, thus avoiding the inefficiency and process interruption associated with the defrosting cycles. The water so produced is of high purity that can be further recovered for residential or industrial consumption, or directly discharged to the ocean without any environmental concerns.

Therefore, it should be especially appreciated that LNG and other cryogenic liquids can be vaporized in configurations and methods in which the refrigeration content of the cryogenic liquid is employed in two sections. In a first section, the refrigeration content is employed to chill ambient air to a temperature of about or slightly above (e.g., 5° F.) the freezing point of water to thereby condense the water from the ambient air. In a second section, the refrigeration content is employed to even further cool the (at least partially) dried air from the first section. Most typically such configurations are operated in counter-current mode in which the second section receives the cryogenic liquid and provides a warmed liquid (or two-phase stream) to the first section.

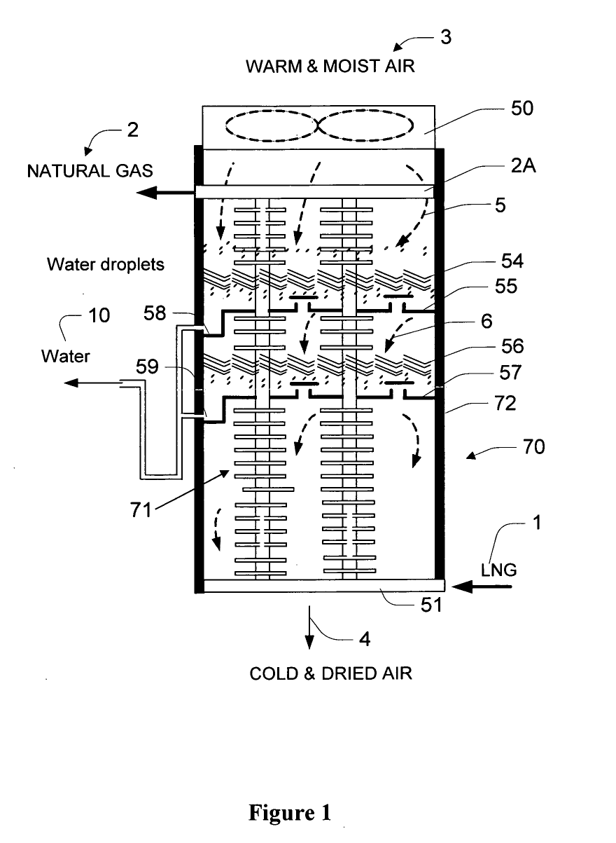

One exemplary ambient air LNG vaporizer is schematically depicted in FIG. 1. Here, pressurized LNG stream 1 at about 1200 to 1600 psig and −260° F. to −250° F. enters the bottom of the ambient air vaporizer 70 via manifold 51. Preferably, the vaporizer 70 includes several vaporization conduits, typically configured as finned exchanger tubes 71, which are partially enclosed in an enclosure 72 such that ambient air stream 5 driven by forced air fan 50 flows downwards and exits the enclosure 72 while heating the LNG inlet stream that enters the bottom of the vaporizer via manifold 51. It should be appreciated that significant quantities of heat are required to vaporize LNG. For example, vaporizing 1 BCFD LNG at 1600 psig requires about 500 mM Btu/h of heat duty. Under such conditions, water in the vaporizer is produced at about 300 to 500 gpm, depending on the relative humidity of the location where the vaporizer is operating.

To coalesce the water mist from the chilled ambient air, it is preferred that multi-stage separator elements are used. Most preferably, the separator elements include a coalescence filter 54 for removal of particulates and liquid droplets, typically through gravitational and/or centrifugal force. The water droplets fall to collector tray 55, are drained to downcomer 58 by gravity, and subsequently removed from the system as stream 10. The separator elements may include one or more layered coalescence filters (e.g., fiberglass/polypropylene composite materials). It is generally preferred that the water-entrained air flows from the inside to the outside of the coalescer filters, and the innermost layer typically acts as a pre-filter to remove submicron droplets. The fibers of the layers capture the fine liquid droplets suspended in the air resulting in droplets to run together and form larger droplets within the coalescence filters. These larger droplets then emerge on the outer surface of the coalescence filters and drain by gravity to the collector tray 55. Where desired, a second stage coalescence filter 56 and water collector tray 57 can be used to further cool and remove residual water from stream 6 via downcomer 59.

The air stream from collector tray 57 is typically at 32° F. to 40° F. and is essentially free of moisture (typically less than 5% relative humidity). The so dehumidified air is then further heat exchanged with LNG in the lower section and exits the bottom of the exchanger at about −100° F. It should be appreciated that the temperature difference between the inlet air 3 and the exit air 4 is in the order of 180° F. Vaporized LNG 2 exits the vaporizer via exit manifold 2A. It should be noted that with such large temperature difference, air flow to the air fans can be significantly reduced.

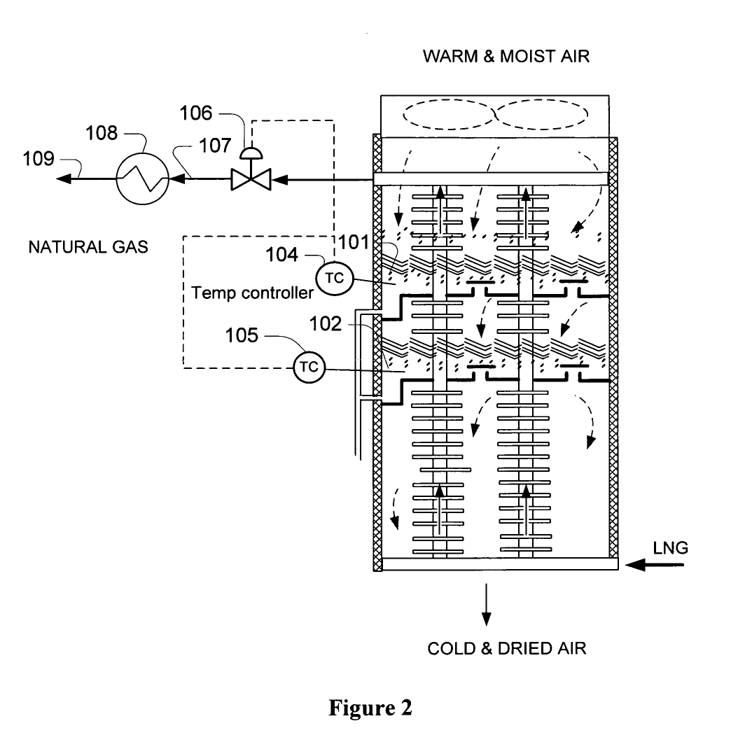

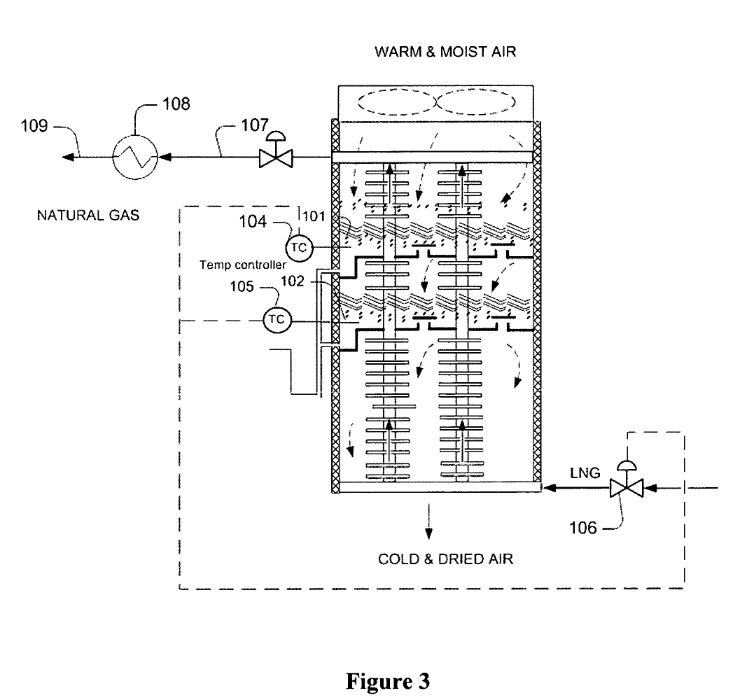

It should still further be noted that ambient air vaporizers are typically designed for the higher duties during summer when ambient temperature and relative humidity are high. During winter operation, when the ambient temperature drops, the air temperature in the upper section(s) will drop correspondingly, and excess overcooling to temperatures below 32° F. to 40° F. may result in frost or ice formation in the upper section that will then require defrosting and/or shutdown of the equipment. To circumvent such problem, it is contemplated that the ambient air vaporizer may further include a defrosting configuration that comprises a control system as schematically depicted in FIG. 2 in which essentially the same configuration is used as in FIG. 1. Here, the upper section temperatures are measured using temperature elements at 101 and 102, and fed to at least one temperature controller, such as TC 104 and/or TC 105. The control mechanism is preferably closely integrated with the temperature control valve 106. When the ambient air temperature drops, the temperature elements 101 and 102 will communicate with temperature controller 104 and 105 that will send a signal to control valve 106 to throttle the natural gas flow leaving the vaporizer. The throttling function will reduce the flow through the vaporizer, effectively lowering the cooling effect from the vaporizing LNG, subsequently increasing the temperature of 101 and 102 to above 32° F. to 40° F., which allows ice buildup to be defrosted. The exit flow 107 from the temperature control valve is further heated in heat exchanger 108, using waste heat, forming exit stream 109 that meets the pipeline temperature specification, typically at 40° F. Similarly, another ambient air LNG vaporizer control system that avoids frost or ice formation is schematically depicted in FIG. 3 in which like numerals refer to like components as compared to FIG. 2. Here, the control valve 106 is located on the inlet LNG line for controlling the LNG flow with a signal from the temperature controller 104 and 105, for maintaining the upper section temperatures at above 32° F. to 40° F. in a similar fashion as in the configuration of FIG. 2.

With respect to the enclosure it is contemplated that especially preferred enclosures will assist forced draft ventilation of the vaporizer. Therefore, suitable enclosures will be open-ended at the top and bottom portions and may further include one or more openings at the side to provide further ventilation. It is also preferred that the enclosures will contain both sections (condensation and heating in upper section and freeze-free heating in lower section) in a continuous configuration. Most typically, the enclosure will enclose between 1 and 100 vaporization conduits, however, larger enclosures are also contemplated. As cold dehydrated air must be discharged from the vaporizer, the enclosure is typically in a raised position on supports. Alternatively, the enclosure may also include a plurality of openings to allow the cold air to vent. Where desired, additional fans or other devices may be implemented to assist air movement within the enclosure.

The vaporization conduits are preferably continuous exchanger tubes that will further include fins or other protruding elements. Where desirable, the conduits will also include additional temperature control elements, and especially suitable elements are conduits for heating fluid. Furthermore, and where desired, the vaporization conduits will be mechanically coupled to each other to stabilize the vaporizer internals.

With respect to the collection tray it is contemplated that all structures are deemed suitable so long as such structures will allow air to pass across the tray into a lower section and condensate to be collected. For example, suitable trays include horizontally arranged trays with a plurality of chimneys (typically covered by a flat or bell-shaped top) to prevent transfer of condensate through the chimney. Alternatively, a plurality of horizontally tilted gutters with U-shaped profile may traverse the enclosure to so separate condensate from the air flow as exemplarily described in U.S. Pat. No. 7,004,988. Contemplated trays will typically be positioned at the lower end of a section in which water is removed from the passing air, and depending on the humidity, the flow rate of air, and/or particular dimensions of the enclosure, contemplated vaporizers will comprise between one and several (e.g., 2-7 or even more) trays.

It is further generally contemplated that as moisture condenses as a relatively fine mist in the respective section(s) of the enclosure, all known manners of coalescing such mist into larger droplets are deemed appropriate for use herein. For example, mist can be removed from the chilled air using all known coalescing filters or devices (e.g., those including microporous materials or microfibers), which may be static devices or rotating devices. It is still further contemplated that additional flow control structures may be present in the enclosure and/or vaporization conduit to impart centrifugal momentum to the chilled air. In still further contemplated aspects, mist may also be coalesced or precipitated using electrostatic methods and/or condensation enhancers. Regardless of the manner of removing water mist from the chilled air it is generally preferred that the coalescence filter will not significantly increase (e.g., >10%) back pressure in the enclosure.

Thus, specific configurations and methods of ambient air vaporizers have been disclosed. It should be apparent, however, to those skilled in the art that many more modifications besides those already described are possible without departing from the inventive concepts herein. The inventive subject matter, therefore, is not to be restricted except in the spirit of the present disclosure. Moreover, in interpreting the specification and contemplated claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. An ambient air vaporizer comprising:
a partitioned enclosure that is configured to at least partially enclose a plurality of vaporization conduits, wherein a first section of the enclosure is separated from a second section by a collection tray;
wherein the first section is configured to allow condensation of water from ambient air at a temperature of at least 32° F. and to allow formation of dehydrated air using the vaporization conduits as cold source;
wherein the collection tray is configured to allow passage of the dehydrated air from the first section to the second section and to allow removal of condensate from the first section;
wherein the second section is configured to allow heating of a cryogenic fluid in the vaporization conduits using the dehydrated air; and
wherein the vaporization conduits extend across the first and second section.

2. The vaporizer of claim 1 wherein the first section comprises a coalescing filter and a drain fluidly coupled to the collection tray.

3. The vaporizer of claim 1 wherein the first and second sections are vertically coupled to each other to allow top-to-bottom air flow.

4. The vaporizer of claim 1 further comprising a fan that is coupled to the enclosure and configured to allow forcing of the ambient air into the first section.

5. The vaporizer of claim 1 further comprising a control system operationally coupled to the vaporizer and configured to at least one of maintain air temperature in the first section above 32° F. and allow defrosting of ice buildup.

6. The vaporizer of claim 5 wherein the control system is configured to maintain the air temperature in the first section by controlling flow of vaporized cryogenic fluid out of the first section.

7. The vaporizer of claim 5 wherein the control system is configured to maintain the air temperature in the first section by controlling flow of the cryogenic fluid into the second section.

8. A vaporizer for a cryogenic fluid, comprising an enclosure with a first section and a second section, both sections at least partially enclosing a vaporization conduit, and wherein first and second sections are configured and dimensioned to allow heating of a cryogenic fluid in the vaporization conduit using air in the second section and to a temperature such that the heated cryogenic fluid has a temperature in the first section effective to condense but not freeze moisture of the air in the first section.

9. The vaporizer of claim 8 further comprising a drain portion and a collection tray that is positioned between the first and second sections, wherein the tray is configured to allow passage of the air from the first to the second section and to allow withdrawal of condensate from the first section.

10. The vaporizer of claim 9 further comprising a fan coupled to the enclosure, wherein the fan is configured to allow forced movement of air from outside the enclosure through the first section, the collection tray, and the second section.

11. The vaporizer of claim 8 further comprising a control system that is configured to maintain air temperature in the first section above 32° F. by controlling flow of the cryogenic fluid in the vaporization conduit.

12. The vaporizer of claim 8 further comprising a control system that is configured to maintain air temperature in the first section by controlling at least one of flow of the cryogenic fluid into the second portion and flow of vaporized cryogenic fluid out of the first portion of the vaporization conduit.

13. The vaporizer of claim 8 further comprising a coalescing filter in the first section.

14. The vaporizer of claim 8 wherein the vaporization conduit is a finned vaporization exchanger tube.

15. A method of vaporizing a cryogenic fluid in a vaporization conduit using ambient air, comprising a step of using partially heated cryogenic fluid to chill and dehydrate the ambient air to a temperature of no lower than 32° F., a step of removing condensate from the dehydrated air, and using the chilled and dehydrated air to form the partially heated cryogenic fluid from the cryogenic fluid.

16. The method of claim 15 wherein the step of dehydrating the ambient air is performed in a first section of a vaporizer that is separate from a second section in which the partially heated cryogenic fluid is formed.

17. The method of claim 16 wherein the temperature of the first section is maintained by a control system that controls flow of the cryogenic fluid in the vaporization conduit to allow ice buildup to be defrosted and removed from the collecting trays.

18. The method of claim 17 wherein the control system controls at least one of efflux of the vaporized cryogenic fluid from the first section and influx of the cryogenic fluid into the second section.

19. The method of claim 16 wherein the step of removing condensate is performed using a coalescence filter and collection tray that is disposed between the first and second sections.

20. The method of claim 15 wherein the cryogenic fluid is liquefied natural gas.
